(19) United States
(12) Patent Application Publication
(10) Pub. No.: US 2013/0168984 A1
(43) Pub. Date: Jul. 4, 2013

(54) INTERNAL PIPE GRIPPING TOOL

(71) Applicant: Jaroslav Belik, (US)

(72) Inventor: Jaroslav Belik, (US)

(21) Appl. No.: 13/342,002

(22) Filed: Dec. 31, 2011

(51) Int. Cl. B66C 1/56; B66C 1/42

(52) U.S. Cl. 294/93; 294/86.4; 294/119.1

(57) ABSTRACT

An internal pipe gripping tool includes a tool body adapted for insertion into a pipe. A gripper is disposed adjacent and movably coupled to the tool body. The gripper has an engaged position and a released position relative to the tool body. A lever has a first end node, a second end node, and an intermediate node between the first and second end nodes. The first end node is coupled to the tool body, and the intermediate node is coupled to the gripper. A force applied to the second end node results in another force at the intermediate node that shifts the gripper from the engaged position to the released position.

### TECHNICAL FIELD

The disclosure relates to methods and apparatus for gripping and pulling pipes.

### BACKGROUND

Internal pipe gripping tools typically have gripping elements that can be inserted into a pipe and forced into contact with the inner wall of the pipe. Once the gripping elements have engaged the inner wall of the pipe, a pulling force may be applied to the gripping tool to pull the gripping tool and pipe. After the pulling operation, the gripping elements may be released from the inner wall of the pipe to allow the gripping tool to be pulled out of the pipe.

U.S. Pat. No. 2,571,619 (“Rusk”) discloses a pipe puller that has a pair of wedge-shaped jaws connected by upper and lower toggle links. The jaws are mounted on an expander wedge. After inserting the pipe puller into a pipe, an auxiliary cable coupled to the upper toggle links is operated such that the jaws ride down the expanded wedge and are forced into frictional contact with the inner wall of the pipe. The toggle links snap into the locked position and keep the jaws in frictional contact with the inner wall of the pipe. With the tool frictionally engaged, another cable coupled to the head of the pipe puller can be used to pull the pipe puller and pipe.

The upper and lower toggle must be moved into the unlocked position in order to be able to release the jaws from frictional contact with the inner wall of the pipe. However, the auxiliary cable is coupled to only the upper toggle link. It does not appear that the auxiliary cable would be effective in moving the lower toggle link to the unlocked position.

### SUMMARY

In one aspect of the disclosure, an internal pipe gripping tool comprises a tool body adapted for insertion into a pipe and at least one gripper disposed adjacent to the tool body. The at least one gripper is movably coupled to the tool body and has an engaged position and a released position relative to the tool body. The internal pipe gripping tool includes at least one lever, which has a first end node, a second end node, and an intermediate node between the first and second end nodes. The first end node is coupled to the at least one gripper, and the intermediate node is coupled to the at least one gripper. A force applied to the second end node results in another force at the intermediate node that shifts the at least one gripper from the engaged position to the released position.

In one embodiment, the tool body has a tapered section and a sliding joint is formed between the at least one gripper and the tapered section. In one embodiment, the sliding joint is inclined at an inclination angle that matches a taper angle of the tapered section.

In one embodiment, the internal pipe gripping tool further includes a linkage coupling the at least one gripper to the intermediate node. In one embodiment, a first end of the linkage is coupled to the intermediate node by a rotating joint. In one embodiment, a second end of the linkage is coupled to the at least one gripper by one of a rotating joint, a sliding joint, and a multiple joint. In one embodiment, the second end of the linkage is coupled to the at least one gripper and the tool body by the multiple joint.

In one embodiment, the at least one lever is coupled to the tool body by a rotating joint.

In one embodiment, the tool body has a plurality of radial fins arranged in a cross design. In one embodiment, at least one of the fins is tapered and the at least one gripper is disposed adjacent to and movably coupled to the tapered fin.

In one embodiment, the internal pipe gripping tool further includes a first link member coupled to the tool body and a second link member coupled to the second end node. The first and second link members provide independent paths for applying force to each of the tool body and second end node of the at least one lever.

In one embodiment, the internal pipe gripping tool further includes a slider movably coupled to the tool body and a link between the at least one lever and the slider. A linear translation of the slide along the tool body in a select direction applies the first force to the second end node of the at least one lever.

In one embodiment, the internal pipe gripping tool further includes a first link member coupled to the tool body and a second link member selectively coupled to the slider. The first and second link members provide independent paths for applying force to each of the slider and tool body.

In one embodiment, the internal pipe gripping tool further includes a second gripper disposed adjacent to the tool body. The second gripper is movably coupled to the tool body, is diametrically opposed to the at least one gripper, and has an engaged position and a released position.

In one embodiment, the internal pipe gripping tool further includes a second lever having a first end node, a second end node, and an intermediate node between the first and second end nodes. The first end node of the second lever is coupled to the tool body. The intermediate node of the second lever is coupled to the tool body. The intermediate node of the second lever is coupled to the second gripper. A force applied to the second end node of the second lever results in another force at the intermediate node of the second lever that shifts the second gripper from the engaged position to the released position.

In another aspect of the disclosure, an internal pipe gripping tool comprises a tool body adapted for insertion into a pipe and at least one gripper disposed adjacent to the tool body. The at least one gripper is movably coupled to the tool body and has an engaged position and a released position relative to the tool body. The internal pipe gripping tool includes a slider coupled to the tool body and linearly movable along the tool body. A link couples the at least one gripper to the slider such that a linear motion of the slider in a select direction applies a force to the at least one gripper that shifts the at least one gripper from the engaged position to the released position.

In another aspect of the disclosure, a method of performing an operation on a pipe comprises providing an internal pipe gripping tool having a tool body, at least one gripper adjacent and movably coupled to the tool body, and at least one lever having a first end node coupled to the tool body, a second end node, and an intermediate node between the first and second end nodes coupled to the at least one gripper. The internal pipe gripping tool is lowered towards the pipe. The lowering continues until the at least one lever reaches a locked position wherein the at least one gripper has engaged the inner wall of the pipe.

In one embodiment, the method further includes applying a force to the tool body to pull both the internal pipe gripping tool and the pipe.

In one embodiment, the method further includes applying another force to the second end node of the at least one lever to move the lever away from the locked position to an unlocked position wherein the at least one gripper is released from the inner wall of the pipe.

### BRIEF DESCRIPTION OF THE DRAWINGS

The accompanying drawings are included to provide a further understanding of the disclosure and are incorporated in and constitute a part of this specification. The drawings illustrate various embodiments of the disclosure and together with the description serve to explain the principles and operation of the invention. The figures are not necessarily to scale, and certain features and certain views of the figures may be shown exaggerated in scale or in schematic in the interest of clarity and conciseness. The following is a description of the figures.

FIG. 1a shows an internal pipe gripping tool.

FIG. 1b shows an enlarged portion of the internal pipe gripping tool of FIG. 1a.

FIG. 2 shows a cross-section of the internal pipe gripping tool of FIG. 1a along lines 2-2 of FIG. 1a.

FIG. 3 shows a cross-section of the internal pipe gripping tool of FIG. 1a along lines 3-3.

FIG. 4 shows a cross-section of the internal pipe gripping tool of FIG. 1b along lines 4-4.

FIG. 5a shows an internal pipe gripping tool suspended above a pipe.

FIG. 5b shows an internal pipe gripping tool being lowered into a pipe.

FIG. 5c shows an internal pipe gripping tool engaged with a pipe.

FIG. 5d shows an internal pipe gripping tool disengaged from a pipe.

FIG. 6a shows another internal pipe gripping tool in a locked position.

FIG. 6b shows the internal pipe gripping tool of FIG. 6a as it is being transitioned from a locked position to an unlocked position.

FIG. 6c shows the internal pipe gripping tool of FIG. 6b in an unlocked position.

FIG. 7 shows another internal pipe gripping tool.

### DETAILED DESCRIPTION

In the following detailed description, numerous specific details may be set forth in order to provide a thorough understanding of embodiments of the disclosure. However, it will be clear to one skilled in the art when embodiments of the disclosure may be practiced without some or all of these specific details. In other instances, well-known features or processes may not be described in detail so as not to unnecessarily obscure the disclosure. In addition, like or identical reference numerals may be used to identify common or similar elements.

FIG. 1a shows an internal pipe gripping tool 100 capable of gripping the inner wall of a pipe. As used herein, the term “pipe” refers to any tubular good that may be gripped from the inside, such as a drill pipe or casing. The internal pipe gripping tool 100 has an axial axis L, a spear 102 having an axial axis that coincides with the axial axis L, and paired grippers 104a, 104b that are diametrically opposed about the axial axis L. The paired grippers 104a, 104b are disposed adjacent to opposite sides of the spear 102 and are each coupled to the spear 102. Each of the paired grippers 104a, 104b is movable relative to the spear 102 by a mechanism 105. Each of the paired grippers 104a, 104b has a wedge shape and can be wedged into frictional contact with an inner wall of a pipe. The outer surfaces of the grippers 104a, 104b to be in opposing relation to the inner wall of the pipe may include gripping elements 107a, 107b, such as teeth or roughened surfaces. The internal pipe gripping tool 100 is adjustable between a locked position, where the grippers 104a, 104b engage with the inner wall of the pipe, and an unlocked position, where the grippers 104a, 104b are disengaged or released from the inner wall of the pipe.

The internal pipe gripping tool 100 is useful wherever there is a desire to grip the inside of a pipe. In one example, the internal pipe gripping tool 100 may be used in a pulling application, where the internal pipe gripping tool 100 will grip a target pipe from the inside and a pulling force applied to the internal pipe gripping tool 100 will pull both the internal pipe gripping tool 100 and the pipe. The internal pipe gripping tool 100 may be used to pull a pipe out of a borehole or mousehole, for example. The internal pipe gripping tool 100 may be coupled to a system that can provide the pulling force, such as a top drive system. In another example, the internal pipe gripping tool 100 may be used in a sealing application, e.g., to seal the bore of a pipe. In this example, the paired grippers 104a, 104b may carry packer elements that will seal against the inner wall of a target pipe when the internal pipe gripping tool 100 is engaged with or locked to the pipe.

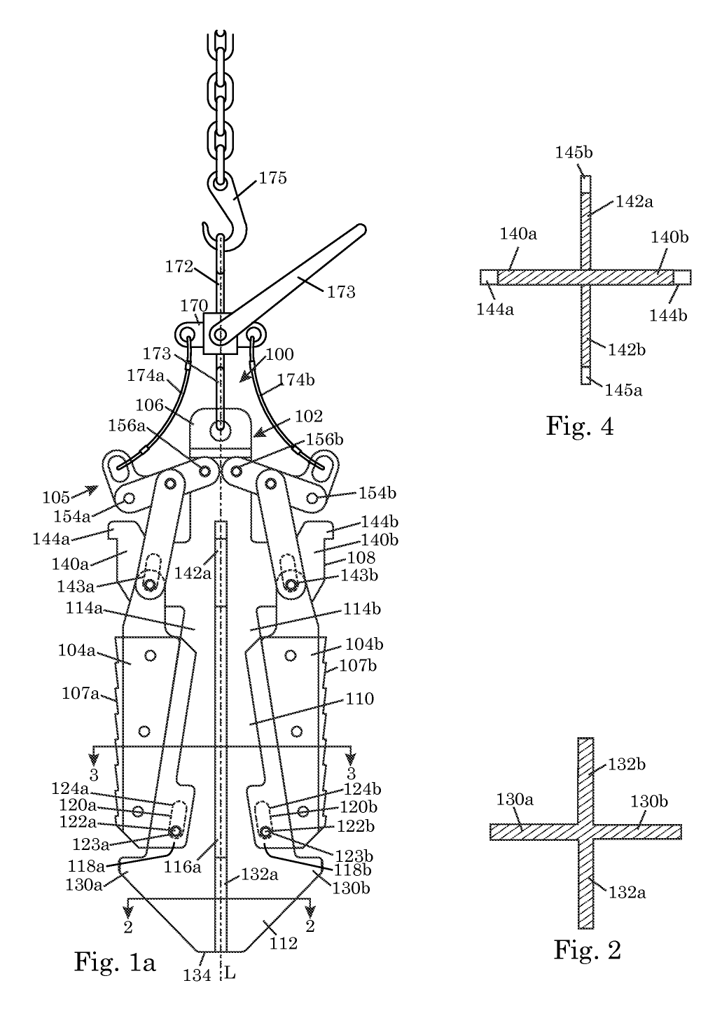

In general, the spear 102 is an elongated body that may be inserted into a pipe. In one embodiment, the spear 102 includes a connector 106, an anchor 108, a body 110, and a nose 112. The parts of the spear 102 may be integrally formed or may be formed separately and then connected together using suitable means such as but not limited to welding. The spear nose 112 has first paired fins 130a, 130b and second paired fins 132a, 132b (in FIG. 2). The fins 130a, 130b, 132a, 132b extend radially relative to the axial axis L. The first paired fins 130a, 130b are diametrically opposed about the axial axis L. Similarly, the second paired fins 132a, 132b are diametrically opposed about the axial axis L. The first paired fins 130a, 130b and second paired fins 132a, 132b together form a cross design (in FIG. 2). However, the spear nose 112 is not restricted to having four fins or fins in a cross design. Other arrangements of fins and number of fins are possible.

Each of the fins 130a, 130b, 132a, 132b is tapered downwardly, from the body end of the spear nose 112 to the tip 134 of the spear nose 112. This gives the spear nose 112 an overall tapered shape. The spear nose 112 may be at the leading end of the internal pipe gripping tool 100 when the internal pipe gripping tool 100 is being lowered into a target pipe. Therefore, the tapered shape of the spear nose 112 would facilitate insertion of the internal pipe gripping tool 100 into the pipe. The spear nose 112 is not restricted to having fins. In some embodiments, the spear nose 112 may have a conical or conical frustum shape in lieu of fins. In other embodiments, the spear nose 112 may have a bull nose shape in lieu of fins. In general, the shape of the spear nose 112 would be selected to facilitate insertion of the internal pipe gripping tool 100 into the target pipe. The overall width of the spear nose 112 should allow the spear nose 112 to be insertable into the pipe without getting stuck in the pipe.

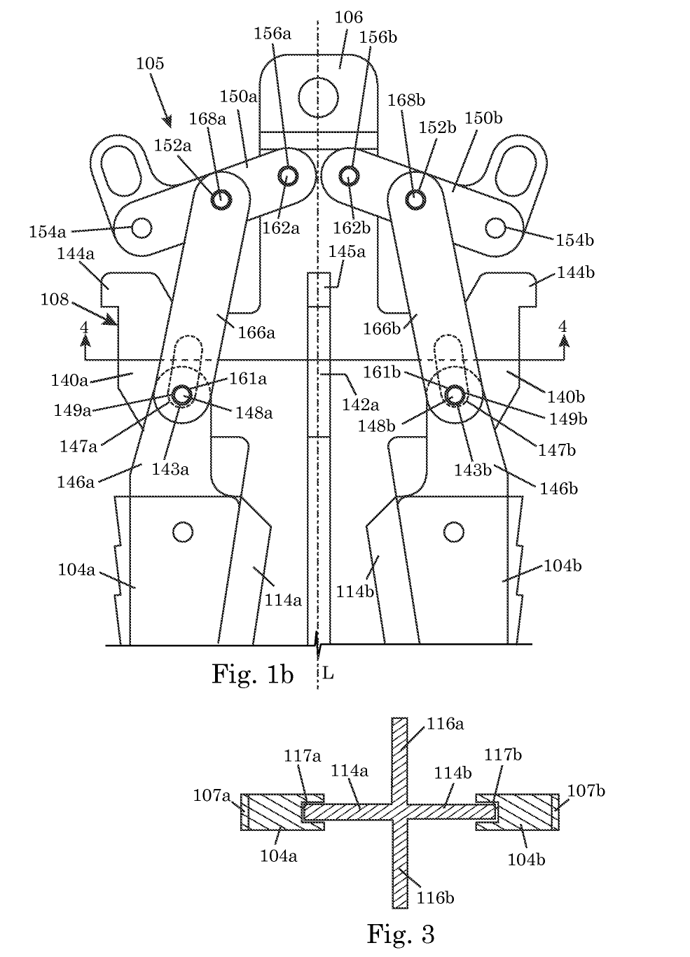

The spear body 110 has first paired fins 114a, 114b and second paired fins 116a, 116b (in FIG. 3). The first paired fins 114a, 114b extend radially relative to the axial axis L and are diametrically opposed about the axial axis L. Similarly, the second paired fins 116a, 116b extend radially relative to the axial axis L and are diametrically opposed about the axial axis L. The spear body first paired fins 114a, 114b may be aligned with the spear nose first paired fins 130a, 130b, respectively. Similarly, the spear body second paired fins 116a, 116b may be aligned with the spear nose second paired fins 132a, 132b, respectively. The spear body first paired fins 114a, 114b and second paired fins 116a, 116b together form a cross design (in FIG. 3). However, the spear body 110 is not restricted to having four fins or fins in a cross design. Other arrangement of fins and number of fins are possible.

The first paired fins 114a, 114b are tapered upwardly, from the nose end of spear body 110 to the anchor end of spear body 110. The fins 114a, 114b extend into slots 117a, 117b (in FIG. 3) in the inner sides of grippers 104a, 104b, respectively. The grippers 104a, 104b are coupled to and movable relative to the fins 114a, 114b, respectively. The tapered edges of the fins 114a, 114b define ramps along which the grippers 104a, 104b, respectively, can move. The positions of the grippers 104a, 104b relative to the spear 102 determine whether the grippers 104a, 104b are in the locked position, where they frictionally engage the inner wall of a pipe, or an unlocked position, where they do not frictionally engage the inner wall of a pipe. The fins 116a, 116b are not coupled to the grippers 104a, 104b.

In general, the spear body 110 may have any number of fins. Typically, some of the fins, e.g., fins 114a, 114b, will cooperate with the grippers 104a, 104b for the locking action of the grippers 104a, 104b with the inner wall of a pipe. The remaining fins, e.g., fins 116a, 116b, may act as centralizers or stabilizers when the internal pipe gripping tool 100 is inserted in a pipe. These remaining fins may or may not be tapered. It is also possible that spear body 110 may not have any fins. For example, the spear body 100 may include a conical frustum shape. This may require a redesign of the inner sides of the grippers 104a, 104b that would be in opposing relation to the spear body 110. In general, the design of the grippers 104a, 104b should be such that the grippers 104a, 104b can move along spear body 110 as the internal pipe gripping tool 100 is shifted between the locked and unlocked positions.

The grippers 104a, 104b are coupled to the spear body fins 114a, 114b by sliding joints 120a, 120b, respectively. The sliding joints 120a, 120b allow the grippers 104a, 104b to move relative to the fins 114a, 114b, respectively. In one embodiment, the sliding joints 120a, 120b are pin-in-slot joints. The sliding joints 120a, 120b may include holes 123a, 123b on lower ears 118a, 118b of the grippers 104a, 104b, respectively. The sliding joints 120a, 120b may further include slots 124a, 124b on the spear body fins 114a, 114b, respectively. The holes 123a, 123b are aligned with the slots 124a, 124b, respectively. Then, pins 122a, 122b are inserted through the aligned slots and holes to complete the sliding joints 120a, 120b. It is possible to reverse the locations of the slots and holes for the sliding joints. That is, the holes may be formed in the fins 114a, 114b and the slots in the gripper ears 118a, 118b. The slots 124a, 124b are inclined upwardly. In one embodiment, the inclination angles of the slots 124a, 124b relative to the axial axis L are selected to match the taper angles of the fins 114a, 114b relative to the axial axis L, respectively. Alternatively, it can be said that the slots 124a, 124b are generally parallel to the tapered edges of the fins 114a, 114b, respectively.

The spear anchor 108 has first paired fins 140a, 140b and second paired fins 142a, 142b (in FIG. 4). The first paired fins 140a, 140b extend radially relative to the axial axis L and are diametrically opposed about the axial axis L. Similarly, the second paired fins 142a, 142b extend radially relative to the axial axis L and are diametrically opposed about the axial axis L. The spear anchor first paired fins 140a, 140b may be aligned with the spear body first paired fins 114a, 114b, and the spear anchor second paired fins 142a, 142b may be aligned with the spear anchor second paired fins 116a, 116b. The spear anchor fins 140a, 140b have lips 144a, 144b, respectively. Similarly, the spear anchor fins 142a, 142b have lips 145a, 145b (in FIG. 4), respectively. The lips 144a, 144b, 145a, 145b function collectively as a flange that may engage an upper end of a pipe and thereby prevent the internal pipe gripping tool 100 from being fully inserted into a target pipe. The lips may simply sit on the rim of the pipe. In alternate embodiments, the lips may be omitted so that the internal pipe gripping tool can be fully inserted into the pipe.

The mechanism 105 for shifting the internal pipe gripping tool 100 between locked and unlocked positions is shown in enlarged view in FIG. 1b. The mechanism 105 has levers 150a, 150b. The lever 150a is a rigid bar with end nodes 154a, 156a and an intermediate node 152a. The intermediate node 152a is between the end nodes 154a, 156a and may or may not be equidistant from the end nodes 154a, 156a. Typically, the intermediate node 152a will be closer to the inner end node 156a. Similarly, the lever 150b is a rigid bar having end nodes 154b, 156b and an intermediate node 152b. Also, the intermediate node 152b is between the end nodes 154b, 156b and may or may not be equidistant from the end nodes 154b, 156b. Typically, the intermediate node 152b will be closer to the inner end node 156b. The end nodes 154a, 156a may also be referred to, alternately, as first and second end nodes. The end nodes 154b, 156b may also be referred to, alternately, as first and second end nodes.

The inner end nodes 156a, 156b are connected to opposite sides of the spear connector 106 by rotating joints 162a, 162b, respectively. In one embodiment, the rotating joints 162a, 162b are pin joints. Force applied to the spear connector 106 may move the spear connector 106 along the axial axis L. Because the inner end nodes 156a, 156b are connected to the spear connector 106, they will move with the spear connector 106. Forces applied to the outer end nodes 154b, 156b will result in forces at the intermediate nodes 152a, 152b, respectively. The intermediate nodes 152a, 152b are coupled to the grippers 104a, 104b, respectively, such that forces at the intermediate nodes 152a, 152b are transferred to the grippers 104a, 104b and are effective in moving the grippers 104a, 104b relative to the spear 102.

With the mechanism 105, force can be applied to the inner end nodes 156a, 156b through the spear connector 106 to lock the internal pipe gripping tool 100 to a pipe or forces can be applied to the intermediate end nodes 152a, 152b through the outer end nodes 154a, 154b to unlock the internal pipe gripping tool 100 from a pipe. FIG. 1a shows one arrangement for applying forces to the nodes. A handle 172 is coupled to the spear connector 106. The handle 172 passes through the center of a pull bar 170, and the pull bar 170 may slide up and down the handle 172. The outer lever end nodes 154a, 154b are coupled to the ends of the pull bar 170 by links 174a, 174b, respectively. In one embodiment, the links 174a, 174b are flexible links, such as cables or chains.

A hook 175 may be used to grab the handle 172 to allow force to be applied to the spear connector 106 through the handle 172. The hook 175 may be connected to a suitable machine capable of supporting and moving weight, such as a top drive. Since the pull bar 170 is not physically connected to the handle 172, the force applied to the handle 172 will not be transferred to the links 174a, 174b, and the links 174a, 174b will remain slack. When it is desired to apply forces to the links 174a, 174b, the hook 175 is disconnected from the handle 172 and connected to the handle 173. The hook 175 is adjusted to move the handle 173 to an upright position and then pull on the handle 173. Since the handle 173 is attached to the pull bar 170, the force applied to the handle 173 will move the pull bar 170 up so that the links 174a, 174b are pulled taut. In this mode, force applied to the handle 173 will be transferred to the links 174a, 174b and ultimately to the outer lever end nodes 154a, 154b. The arrangement of handles, pull bar, and links allow forces to be applied separately or independently to the spear connector 106 and outer lever end nodes 154a, 154b. That is, force can be applied to the spear connector and not the outer lever end nodes, or vice versa. Other arrangements that can allow forces to be applied separately to the spear connector 106 and outer lever end nodes 154a, 154b may be used.

In FIG. 1b, the intermediate nodes 152a, 152b are coupled to the grippers 104a, 104b by linkages 166a, 166b, respectively. Rotating joints 168a, 168b, such as pin joints, are formed between the linkages 166a, 166b and the intermediate nodes 152a, 152b, respectively. In one embodiment, multiple joints 147a, 147b are disposed between the linkages 166a, 166b, the grippers 104a, 104b, and the spear anchor fins 140a, 140b. In one embodiment, the multiple joints 147a, 147b are each a combination of a rotating joint and a sliding joint. For example, the linkages 166a, 166b have holes 161a, 161b, respectively. The grippers 104a, 104b have upper ears 146a, 146b, and holes 143a, 143b are formed in the gripper ears 146a, 146b, respectively. The spear anchor fins 140a, 140b have slots 149a, 149b, respectively. The multiple joint 147a is formed by aligning hole 161a, hole 143a, and slot 149a and inserting pin 148a through the aligned holes and slot. Similarly, the multiple joint 147b is formed by aligning hole 161b, hole 143b, and slot 149b and inserting pin 148b through the aligned holes and slot.

The multiple joints 147a, 147b provide pin-in-slot joints between the spear anchor fins 140a, 140b and linkages 166a, 166b, respectively. Also, the multiple joints 147a, 147b provide pin joints between the upper gripper ears 146a, 146b, respectively. However, it is possible to separate out the pin-in-slot and pin joints instead of combining them into multiple joints. What is important is that forces applied to the intermediate nodes 152a, 152b can be used to move the grippers 104a, 104b relative to the spear 102 in a guided fashion. For example, pin-in-slot joints may be formed between the spear anchor fins 140a, 140b and the grippers 104a, 104b, respectively, and pin joints may be formed between the linkages 166a, 166b and the grippers 104a, 104b, respectively. In this way, the pin joints will allow the grippers 104a, 104b to move with the linkages 166a, 166b, respectively, and the motion of the grippers 104a, 104b relative to the spear 102 is guided by the pin-in-slot joints.

For the configuration shown in FIG. 1b, when pulling forces are applied to the intermediate nodes 152a, 152b, the linkages 166a, 166b will move up. As the linkages 166a, 166b move up, the grippers 104a, 104b will also move up, and so will the pins 148a, 148b. In one embodiment, the slots 143a, 143b are parallel to the slots 124a, 124b (in FIG. 1a), respectively. This enables the grippers 104a, 104b to move along the ramp created by the tapered edges of the body fins 114a, 114b.

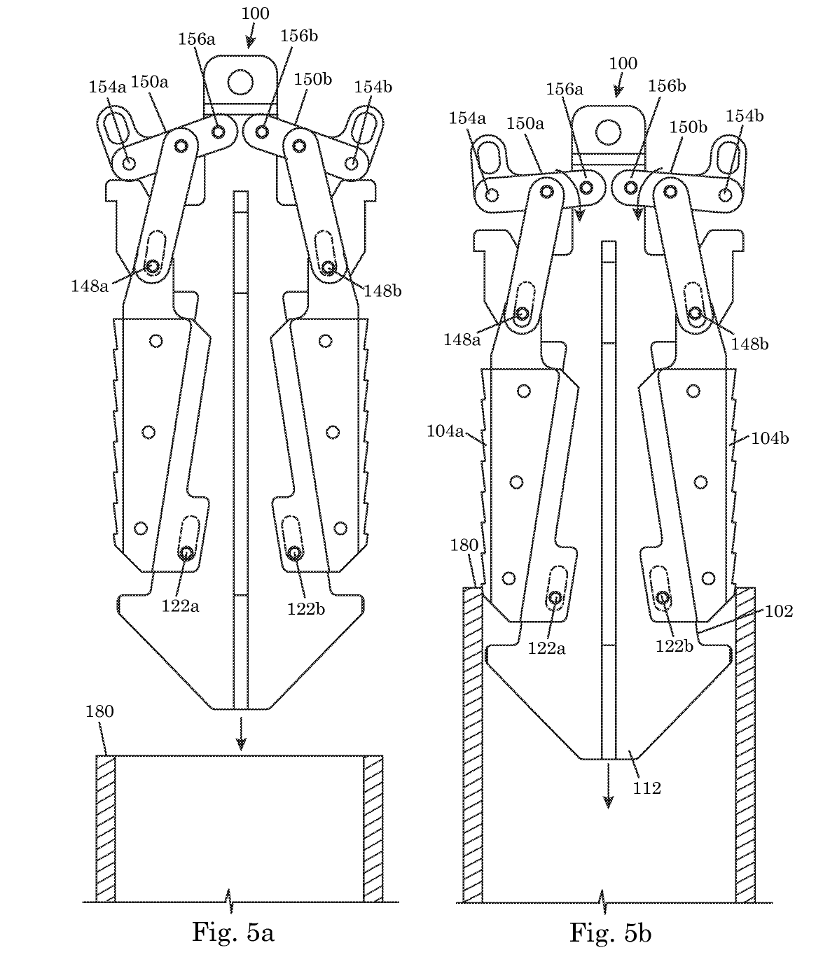

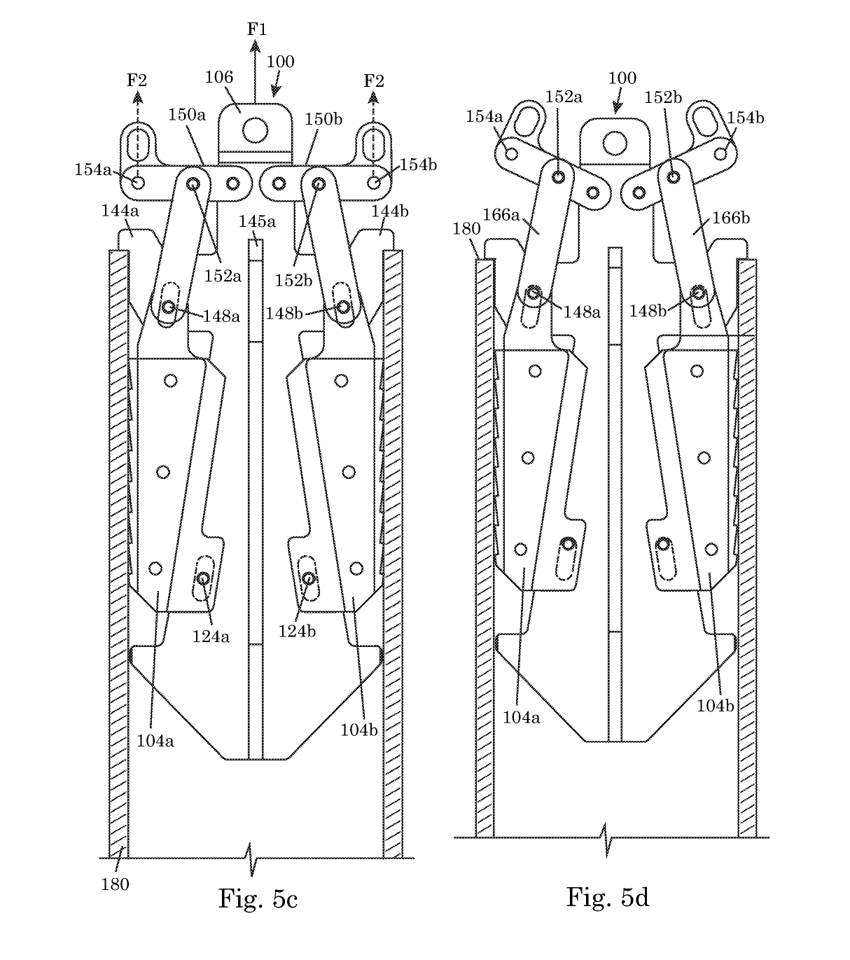

In FIG. 5a, the internal pipe gripping tool 100 is being lowered into a pipe 180. In this state, in one embodiment, the levers 150a, 150b are tilted upwardly, with the inner end nodes 156a, 156b being axially displaced from or higher than the outer end nodes 154a, 154b. The pins 148a, 148b, 122a, 122b are at the lowermost positions in their respective slots. In alternate embodiments, it may be possible to configure the levers 150a, 150b such that the levers are tilted downwardly or are horizontal while the pipe is being lowered.

In FIG. 5b, the spear nose 112 has been inserted into the pipe 180, and the internal pipe gripping tool 100 is still being lowered into the pipe 180. In this state, frictional forces are being created from contact between the grippers 104a, 104b and the inner wall of the pipe 180. The net forces acting on the internal pipe gripping tool 100 result in a relative motion between the grippers 104a, 104b and the spear 102, whereby the spear 102 moves axially or down relative to the grippers 104a, 104b. As the spear 102 moves down, the levers 150a, 150b begin to rotate inwardly. That is the inner end nodes 156a, 156b begin to move down, or axially downward, and the end nodes 154a, 154b begin to move up, or axially upward. Also, pins 148a, 148b, 122a, 122b begin to move up their respective slots.

In FIG. 5c, the levers 150a, 150b have reached a locked position. In one embodiment, the levers 150a, 150b are horizontal in the locked position. In alternate embodiments, it may be possible to configure the levers 150a, 150b such that they are not horizontal in the locked position. The grippers 104a, 104b have frictionally engaged the inner wall of the pipe 180, forming wedges between the inner wall of the pipe 180 and spear 102. Anchor lips 144a, 144b, 145a, 145b (in FIG. 4) are sitting at the upper end of the pipe 180. The pins 148a, 148b, 122a, 122b are about midway in their respective slots. A pulling force F1 may be applied to the pipe gripping tool 100 via the spear connector 106 to pull both the internal pipe gripping tool and the pipe 108.

To unlock the internal pipe gripping tool 100 from the pipe 108, the outer end nodes 154a, 154b are pulled up, as indicated by arrows F2. This causes the intermediate nodes 152a, 152b to axially displace or move up, as shown in FIG. 5d. The forces created at the intermediate nodes 152a, 152b will be determined by the mechanical advantage of the levers 150a, 150b and may be several times higher than the forces applied at the outer end nodes 154a, 154b. As the intermediate nodes 152a, 152b move up, they pull up the linkages 166a, 166b and grippers 104a, 104b. Eventually, the grippers 104a, 104b will be released from the inner wall of the pipe 180. This may be when the pins 148a, 148b, 122a, 122b are at the uppermost positions in their respective slots. In one embodiment, the levers 150a, 150b are tilted downwardly when the grippers 104a, 104b are released from the inner wall of the pipe 180. In alternate embodiments, it may be possible to configure the levers 150a, 150b such that they are not tilted upwardly or are horizontal when the grippers are released. Once the grippers 104a, 104b are released, the internal pipe gripping tool 100 can be removed from the pipe 180.

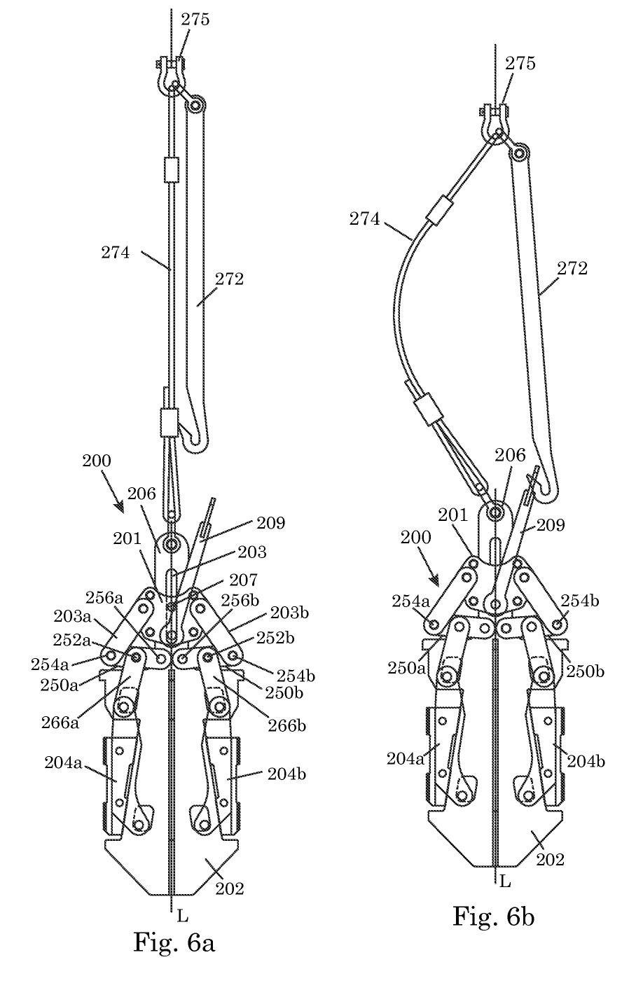

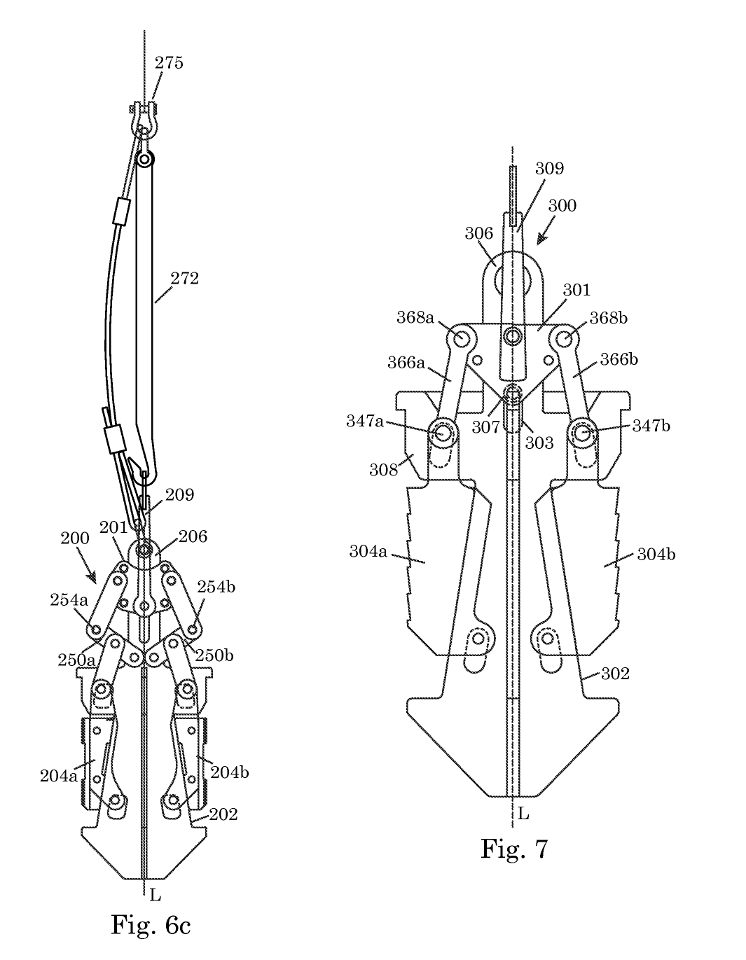

FIG. 6a shows an internal pipe gripping tool 200, which is the pipe gripping tool 100 with a modification to the mechanism for shifting the tool between the locked and unlocked positions. The pipe gripping tool 200 has a spear 202 and paired grippers 204a, 204b. The paired grippers 204a, 204b are adjacent to and movably coupled to the spear 202 as explained above for the internal pipe gripping tool 100. A slide 201 is mounted on the spear connector 206 and movable linearly along axial axis L of the internal pipe gripping tool 200. The slide 201 may be a bracket with a pin 207 at its underside that fits into a linear slot 203 in the spear connector 206. A handle 209 is attached to the slide 201.

The internal pipe gripping tool 200 has levers 250a, 250b. The inner end nodes 256a, 256b of the levers 250a, 250b are attached to the spear connector 206 at a position axially displaced from or below the slide 201. Intermediate nodes 252a, 252b of the levers 250a, 250b are coupled to the grippers 204a, 204b via linkages 266a, 266b and moving (or multiple) joints as explained above for the internal pipe gripping tool 100 (in FIG. 6a, nodes 252a, 252b are behind linkages 266a, 266b, respectively, at the locations indicated by 252a, 252b). Linkages 203a, 203b couple outer end nodes 254a, 254b of the levers 250a, 250b to the slide 201. The joints between the linkages 203a, 203b and the outer end nodes 254a, 254b may be rotating joints, such as pin joints. Similarly, the joints between the linkages 203a, 203b and the slide 201 may be rotating joints, such as pin joints.

A cable 274 has one end coupled to a union 275 and another end coupled to the spear connector 206. A hook 272 has one end coupled to the union 275 and another end that may be selectively coupled to the handle 209. When the hook 272 is not coupled to the handle 209, the slide 201 moves to its lower position on the connector part 206 due to gravity. Also, the cable 274 is taut due to the weight of the pipe gripping tool 200 and gravity. In this position, the internal pipe gripping tool 200 may be inserted into a pipe, and the mechanism for gripping the pipe would be the same as explained above for the internal pipe gripping tool 100. Once the internal pipe gripping tool 200 has gripped the pipe, it is possible to pull up the internal pipe gripping tool 200 and pipe. When it is desired to unlock the internal pipe gripping tool 200 from the pipe, the hook 272 will be connected to the handle 209 of the slider 201, as shown in FIG. 6b, and then used to move the slider 201 up the spear connector 206, as shown in FIG. 6c. This will move the outer end nodes 254a, 254b of the levers 250a, 250b up, releasing the grippers 204a, 204b from the pipe. The mechanism for releasing the grippers 204a, 204b is the same as explained above for the internal pipe gripping tool 100.

FIG. 7 shows an internal pipe gripping tool 300, which is the internal pipe gripping tool 100 with a modification to the mechanism for shifting the tool between the locked and unlocked positions. The internal pipe gripping tool 300 has a spear 302 and grippers 304a, 304b, which are adjacent and movably coupled to the spear 302 as explained above for internal pipe gripping tool 100. A slide 301 is mounted on the spear connector 306 of the spear 302 and movable linearly along axial axis L of the internal pipe gripping tool 300. The slide 301 may be a bracket with an associated pin 307 that fits into a linear slot 303 in the spear connector 306. A handle 309 is attached to the slide 301. The internal pipe gripping tool 300 does not have levers. Rather, linkages 366a, 366b are coupled at one end to the grippers 304a, 304b and spear anchor 308 via multiple joints 347a, 347b. Also, linkages 366a, 366b are coupled at the other end to the slider 301 via rotating joints 368a, 368b such as pin joints. The grippers 304a, 304b will move as the slider 301 moves. To lock the internal pipe gripping tool 300 to a pipe, the internal pipe gripping 300 is inserted into a pipe and the slider 301 is allowed to fall to a lower position on the spear connector 306. To unlock the internal pipe gripping tool 300 from a pipe, the slider 301 is moved up the spear connector 306.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. An internal pipe gripping tool, comprising:
a tool body having a central axis and is adapted for insertion into a pipe;
at least one gripper disposed adjacent to the tool body, the at least one gripper being movably coupled to the tool body and having an engaged position and a released position relative to the tool body; and
at least one lever coupled to the tool body at a first location on the lever, the at least one lever coupled to the at least one gripper at a second location on the lever, wherein a force applied to the lever at a third location results in another force that shifts the at least one gripper from the engaged position to the released position;
wherein the force applied to the lever at the third location is oriented in an axially upward direction.

2. An internal pipe gripping tool according to claim 1, wherein the tool body has a tapered section and a sliding joint is formed between the at least one gripper and the tapered section.

3. An internal pipe gripping tool according to claim 2, wherein the sliding joint is inclined at an inclination angle that matches a taper angle of the tapered section.

4. An internal pipe gripping tool according to claim 1, further comprising a linkage coupled to the lever at the third location.

5. An internal pipe gripping tool according to claim 4, wherein a first end of the linkage is coupled to the lever at the third location by a rotating joint.

6. An internal pipe gripping tool according to claim 5, wherein a second end of the linkage is coupled to the at least one gripper by one of a rotating joint, a sliding joint, and a multiple joint.

7. An internal pipe gripping tool according to claim 6, wherein the second end of the linkage is coupled to the at least one gripper and the tool body by the multiple joint.

8. An internal pipe gripping tool according to claim 1, wherein the at least one lever is coupled to the tool body by a rotating joint.

9. An internal pipe gripping tool according to claim 1, wherein the tool body has a plurality of radial fins arranged in a cross design.

10. An internal pipe gripping tool according to claim 9, wherein at least one of the fins is tapered and the at least one gripper is disposed adjacent to and movably coupled to the tapered fin.

11. An internal pipe gripping tool according to claim 1, further comprising a first link member coupled to the tool body and a second link member coupled to the lever at the third location, the first and second link members providing independent paths for applying force to each of the tool body and the third location of the at least one lever.

12. An internal pipe gripping tool according to claim 1, further comprising a slider movably coupled to the tool body and a link between the at least one lever and the slider, wherein a linear translation of the slider along the tool body in a select direction applies the first force to the at the third location of the at least one lever.

13. An internal pipe gripping tool according to claim 12, further comprising a first link member coupled to the tool body and a second link member selectively coupled to the slider, the first and second link members providing independent paths for applying force to each of the slider and tool body.

14. An internal pipe gripping tool according to claim 1, further comprising a second gripper disposed adjacent to the tool body, the second gripper being movably coupled to the tool body, being diametrically opposed to the at least one gripper, and having an engaged position and a released position.

15. An internal pipe gripping tool according to claim 14, further comprising a second lever coupled to the tool body at a first location on the second lever, the second lever coupled to the second gripper at a second location on the second lever, wherein a force applied to a third location on the second lever results in another force that shifts the second gripper from the engaged position to the released position.

16. An internal pipe gripping tool, comprising:
a tool body adapted for insertion into a pipe;
at least one gripper disposed adjacent to the tool body, the at least one gripper being movably coupled to the tool body and having an engaged position and a released position relative to the tool body;
a slider coupled to the tool body and linearly movable along the tool body; and
a link coupling the at least one gripper to the slider such that a tension force applied to the slider shifts the at least one gripper from the engaged position to the released position.

17. A method of performing an operation on a pipe, comprising:
providing an internal pipe gripping tool having a spear, at least one gripper disposed adjacent to the spear and movably coupled to the spear, and at least one lever coupled to the at least one gripper;
lowering the internal pipe gripping tool towards the pipe;
continuing lowering of the internal pipe gripping tool until the at least one lever reaches a locked position wherein the at least one gripper has engaged the inner wall of the pipe; and
disengaging the at least one lever from the inner wall of the pipe to reach a released position by applying a first axially upward oriented force to the lever.

18. The method of claim 17, further comprising applying a second force to the tool body to pull both the internal pipe gripping tool and the pipe.

19. (canceled)

20. The internal pipe gripping tool according to claim 16, wherein the tool body has a tapered section and a sliding joint is formed between the at least one gripper and the tapered section.

21. The internal pipe gripping tool according to claim 20, wherein the sliding joint is inclined at an inclination angle that matches a taper angle of the tapered section.

22. The internal pipe gripping tool according to claim 16, wherein the tool body has a tapered section and a sliding joint is formed between the at least one gripper and the tapered section.

23. The internal pipe gripping tool according to claim 16, wherein the tool body has a plurality of radial fins arranged in a cross design.

24. The internal pipe gripping tool according to claim 16, further comprising a second gripper disposed adjacent to the tool body, the second gripper being movably coupled to the tool body, being diametrically opposed to the at least one gripper, and having an engaged position and a released position.
